(19) United States
(12) Patent Application Publication
(10) Pub. No.: US 2008/0289515 A1
(43) Pub. Date: Nov. 27, 2008

(54) PEPPER DE-STEMMING

(76) Inventors: Robert J. Knorr, Maricopa, AZ (US); John Victor, Cochise, AZ (US)

Correspondence Address: JENNINGS, STROUSS & SALMON, P.L.C., 201 E. WASHINGTON ST., 11TH FLOOR, PHOENIX, AZ, 85004, US

(21) Appl. No.: 12/104,334

(22) Filed: Apr. 16, 2008

Related U.S. Application Data
(60) Provisional application No. 60/912,405, filed on Apr. 17, 2007.
(60) Provisional application No. 60/947,281, filed on Jun. 29, 2007.
(60) Provisional application No. 61/016,071, filed on Dec. 21, 2007.

(51) Int. Cl. A23N 15/02

(52) U.S. Cl. 99/640; 460/134; 99/637

(57) ABSTRACT

A way of dealing with challenges to the pepper processing industry and pepper growers is to mechanize pepper processing, including the de-stemming of whole peppers. The present example provides a method of or mechanically de-stemming whole peppers. The method provides for the recognition of a pepper's shoulder in order to generate a control signal to initiate a process to de-stem the pepper. In particular, several implementations of the method are provided that may include a mechanical system, a laser system, a machine vision system, a combination of a machine vision system and the laser system, and other equivalent implementations. Additionally disclosed, are methods of processing whole peppers utilizing automated de-stemming.

### TECHNICAL FIELD

This description relates generally to food harvesting and processing and more specifically to the harvesting and processing of fruits and vegetables having a recognizable shoulder, such as whole peppers.

### BACKGROUND

Harvesting and processing of whole peppers is typically labor intensive. When whole peppers are picked, they are usually hand graded in the field. Likewise, de-stemming is a labor intensive process to remove the stem and the calyx of the pepper from the pepper pod. De-stemming may be done in the field at harvest, or may be done by hand during processing of the whole peppers, typically before the whole peppers are processed for products, such as salsa, or are processed further, such as being canned.

A trend in the agriculture industry is the increase in labor costs and the continuing effort to find low cost labor, typically migrant or seasonal laborers. However, the availability of this low cost labor source has recently diminished. This decrease in the availability of cost effective local labor can create challenges to a grower's ability to harvest and process whole peppers. In addition, processing may be outsourced to foreign countries where labor may be available at low cost, but adding transportation costs to the total cost of processing.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A way of dealing with challenges to the pepper processing industry and pepper growers is to mechanize pepper processing, including the de-stemming of whole peppers. The present example provides a method of for mechanization the de-stemming of whole peppers. The method provides for the recognition of a pepper's shoulder in order to generate a control signal to initiate a process to de-stem the pepper. In particular, several implementations of the method are provided that may include a mechanical system, a laser system, a machine vision system, a combination of a machine vision system and the laser system, and other equivalent implementations. Additionally disclosed, are methods of processing whole peppers utilizing mechanized de-stemming.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a conventional method of de-stemming a pepper.

FIG. 2 shows a typical pepper to be de-stemmed.

FIG. 3 is a flow chart of a method of de-stemming a pepper utilizing mechanical or laser, shoulder recognition.

FIG. 4 is a flow chart of a method of de-stemming a pepper utilizing machine vision or a combination of machine vision and laser shoulder recognition.

FIG. 5 is a schematic showing a pepper de-stemmer utilizing mechanical shoulder recognition.

FIG. 6 is a schematic showing a pepper de-stemmer utilizing laser shoulder recognition.

FIG. 7 is a schematic showing a pepper de-stemmer utilizing machine vision shoulder recognition.

FIG. 8 is a schematic showing a pepper de-stemmer utilizing machine vision and laser shoulder recognition.

FIG. 9 shows a perspective view of an example of a pepper de-stemming machine utilizing machine vision shoulder recognition and a horizontal belt system to feed whole peppers for de-stemming.

FIG. 10 shows a side view of the example of a pepper de-stemming machine utilizing machine vision shoulder recognition and a horizontal belt system to feed whole peppers for de-stemming.

FIG. 11 shows a perspective view of an example of a pepper de-stemming machine utilizing laser shoulder recognition and an inclined quadruple belt system to feed whole peppers for de-stemming.

FIG. 12 shows a side view of an example of a pepper de-stemming machine utilizing laser shoulder recognition and an inclined quadruple belt system to feed whole peppers for de-stemming.

FIG. 13 shows an assembly of an example of a modularized pepper de-stemming machine into a production line for flexibility in production capacity and maintenance.

FIG. 14 shows an example of a pepper de-stemmer working in conjunction with additional components for processing whole peppers such as singularity processing, grading whole peppers and the like.

FIG. 15 shows a floor plan for a pepper processing facility utilizing pepper de-stemming machinery.

FIG. 16 is a flow diagram showing pepper processing in a facility utilizing pepper de-stemming machinery.

FIG. 17 is a block diagram of a computer system for providing control signals for implementing a method of de-stemming a pepper utilizing mechanical, or laser, shoulder recognition.

FIG. 18 shows a cutting assembly with a hold down to keep the pepper from flipping when cut.

The APPENDIX shows various views of an example of a vision based pepper de-stemming machine.

Like reference numerals are used to designate like parts in the accompanying drawings.

### DETAILED DESCRIPTION

Whole pepper de-stemming as used in this document is defined as the process of removing the stem, calyx and the woody tissue (or placenta) associated with the stem and the calyx. De-stemming of this type is typically aimed at producing a remaining pepper pod that has the previously mentioned items removed, without removing so much material that the cavity of the pepper is opened to outside air. Intrusion of air in the pepper lobe tends to promote bacteria growth and pepper decay. Thus, it is desirable to leave enough placenta to seal the pepper lobe when de-stemming. De-stemming on this manner tends to increase the shelf life of the peppers, in part because of a reduced respiration with this type of de-stemming.

This disclosure describes examples of a pepper de-stemming machine, that utilize shoulder recognition to identity and the shoulder and subsequently remove the stem and calyx of a whole pepper. As used in this application a whole pepper generally refers to a pepper in its as-picked condition from the field. Shoulder recognition can be implemented by various mechanical, electrical, or optical systems. The whole peppers that may have their stems and calyx removed, include jalapeño's, long green Anaheim chili peppers, and in general all varieties of peppers. The de-stemmer typically recognizes the shoulder of a pepper, cuts off the stem and calyx, and transports the pepper for further processing.

In one example of recognizing a shoulder of a pepper a vision system, (or area continuance vision system, or real time processing vision system) may be used. In this system a pepper passes over an area of fluorescent material. In this example the orientation of the pepper and its shoulder are recognized by examining the pixels associated with the fluorescent material that are not covered by the pepper. Examination may be made on a pixel by pixel basis or by examining selectively positioned image windows. In this example a Keyence Vision System with sufficient programming or its equivalent may be used.

In recognizing the shoulder of the pepper, mechanical switches, or a machine vision system may be used to implement shoulder recognition as described above. In addition, a combination of a laser sensor system and machine vision system may be utilized in an alternative example. In a typical pepper starting at the shoulder, moving towards the Apex (or blossom end), the width of the pepper typically decreases on both sides of the pod. At the apex end of the pepper opposite the stem, the pepper may curl to one side. However, this method described above typically deals with these irregularities in shape.

The method of de-stemming described may when applied to a pepper processing system having a feed system, a shoulder recognition system, a cutting system and a stem separator that tends to produce a pod that is intact. Such a pod is ready for processing or may be stored with typically better shelf life than currently available.

The detailed description provided below in connection with the appended drawings is intended as a description of the present examples of a pepper de-stemmer and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a process for de-stemming a pepper (or other vegetables). Although the present examples are described and illustrated herein as being implemented in mechanical, laser, machine vision, and laser and machine vision systems, the systems described are provided as an example and not a limitation. As those skilled in the art will appreciate, the present examples are suitable for application in a variety of different types of pepper (or other vegetables) de-stemming systems.

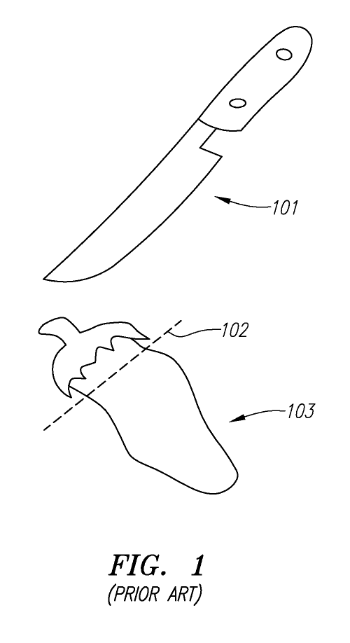

FIG. 1 shows a conventional method of de-stemming a pepper. A pepper 103 typically includes a cap (or calyx) and a stem that may be removed and discarded before the pepper is further processed for use in food products. Pepper processing is typically labor intensive as it is done usually with a knife or by hand. A typical method of de-stemming a pepper 103 is for a person to use a knife 101 to cut off the calyx and stem typically of each pepper at a line 102 near the calyx and stem. Alternatively a person may pull or break the stem off or calyx by hand.

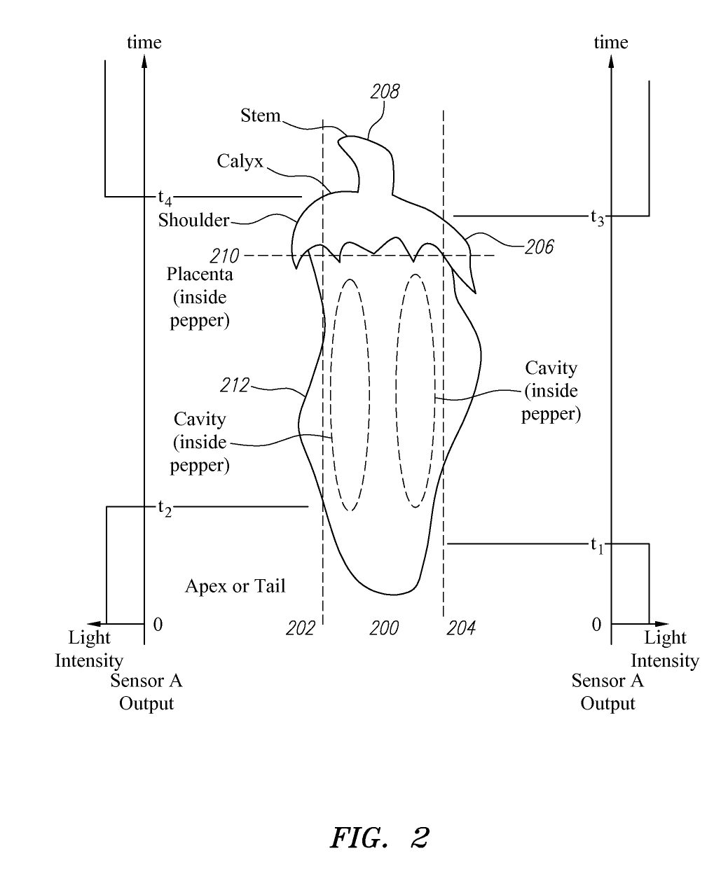

FIG. 2 shows a typical whole pepper to be de-stemmed. The typical terms used to describe a pepper are indicated in this drawing and in the first photo in the appendix. A typical whole pepper 200 includes a stem 208 and a calyx 206. In food processing, it is typically desired to separate the calyx 206 and stem 208 from the body of the pepper 212, typically at a line 210. In de-stemming a pepper, it is typically desired to place the cut 210 such that as much of the body of the pepper 212 as possible is retained for further processing into food products, and such that the cavity is not exposed to outside air.

A method of shoulder recognition takes advantage of the typical shape of a pepper to remove the stem. The method allows the cut 210 to be placed such that the stem 208 and calyx 206 are removed from a pepper typically resulting in a minimal waste of the body of the pepper 212.

To implement shoulder recognition, two or more sensors may be disposed beneath the path of a pepper 200 being processed in one example of a pepper de-stemming machine. In another example of a pepper de-stemming machine to be described, a vision system may be used.

The pepper 200 generally passes above the sensors in the line of travel denoted by lines 202 and 204 when it is fed into the de-stemming machine. At least two light sources supply light to the sensors to allow detection of the shape of the pepper. For example, light sources, such as lasers, may be disposed above the pepper 200 to shine into a sensor disposed beneath the pepper until the pepper blocks the light. For two sensors, sensor A and sensor B, their output may be as shown as the pepper passes over the sensor. Before the pepper reaches either sensor, a light intensity is recorded by the sensors. As the pepper body covers the sensors, the light intensity is reduced or eliminated as shown at time t₁ and time t₂. As the pepper travels down the line, the light sensors are uncovered producing a light reading at the sensors generally indicated at time t₃ and t₄ time. Thus, by utilizing the shape of the pepper, the shoulder of the pepper may be detected using the sensors. Once the shoulder of the pepper is detected, a signal is produced to cause removal of the stem and calyx from the pepper at line 210. Alternatively, mechanical switches, vision recognition systems, or a combination of vision and laser may be used to detect the pepper shoulder.

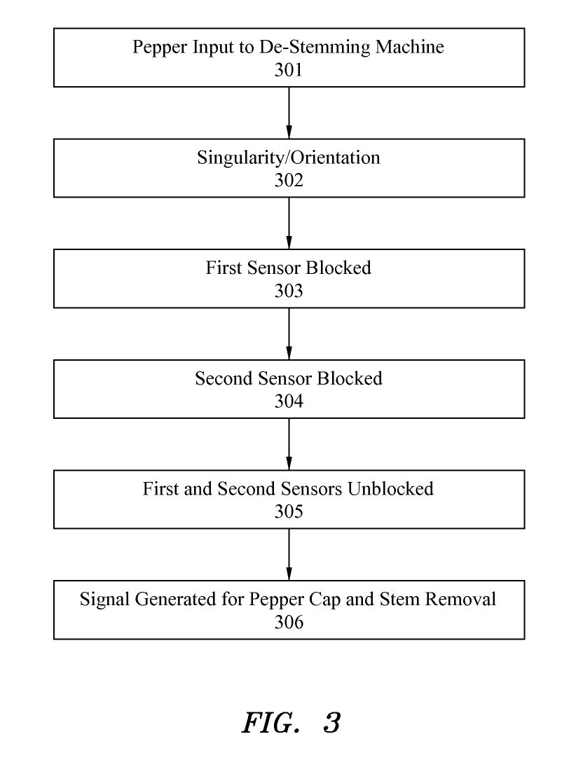

FIG. 3 is a flow chart of a method of de-stemming a pepper utilizing mechanical, or laser, shoulder recognition. First, a pepper is provided to the input of a pepper de-stemming machine 301. Next, the pepper is oriented such that the apex end of the pepper is presented to the de-stemming machine first 302. Next, the pepper travels into the de-stemming machine such that a first sensor is blocked by the body of the pepper 303. At nearly the same time, a second sensor is blocked by the body of the pepper 304. As the pepper travels further into the de-stemming machine, either the first sensor or the second sensor is unblocked by the body of the pepper then the other 305. A reading is produced at the first sensor, and the second sensor that may then cause a knife mechanism to remove the pepper calyx once the pepper travels underneath an automated knife 306.

In the mechanical switch activated shoulder recognition example, and the laser and sensor combination examples used in shoulder recognition, the control systems may be manually adjusted to provide the proper timing for the de-stemming of the pepper. For example, motor speed governing the belt may be adjusted and the time between shoulder recognition and actuation of the knife blade may be adjusted by hand.

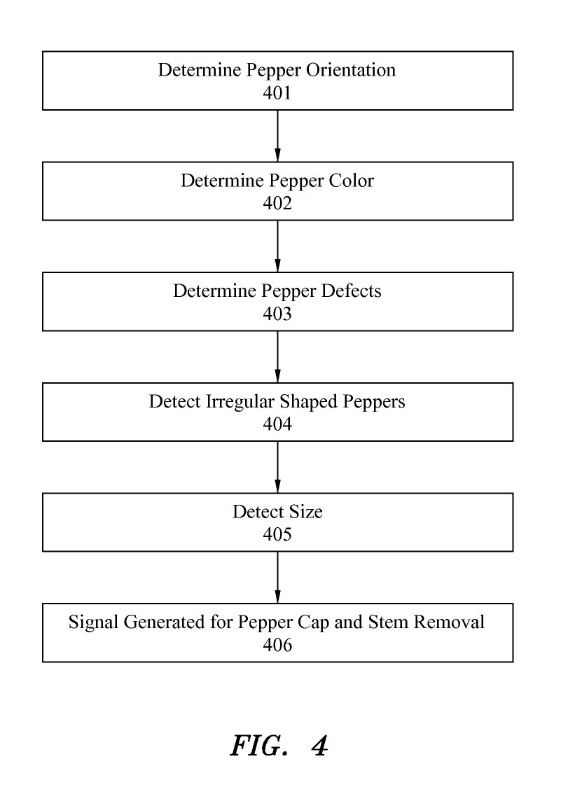

FIG. 4 is a flow chart of a method of de-stemming a pepper utilizing machine vision or a combination of machine vision and laser shoulder recognition. In an example of a pepper de-stemmer utilizing machine vision, in addition to shoulder recognition, the machine vision pepper de-stemmer may detect the orientation of the pepper 401 in a chute, or on a belt, feeding the de-stemmer so that apex first or stem first orientation of the pepper in the cluster or on its belt may be detected.

Also, the vision system can allow for detection of the color 402 of the pepper for grading a separate purpose. Previously, color differentiation may have been handled by selective harvesting, or a color sorting machine. Now, color differentiation or sorting may be achieved while de-stemming on a single machine allowing for more efficient processing.

The vision system may also detect defects 403 in the pepper. For example, if the pepper being fed into the machine is not whole, or is broken, the de-stemming machine may detect this. In an alternative example, the machine vision pepper de-stemmer may also be capable of detecting blemished peppers by color recognition. And finally, machine vision may allow shape recognition to detect crooked peppers 404. The machine vision pepper de-stemmer also allows for size recognition 405 of the various types of peppers, for example, jalapeños peppers may be much smaller than the large varieties of chili peppers. And finally, a signal is generated to de-stem the pepper 406.

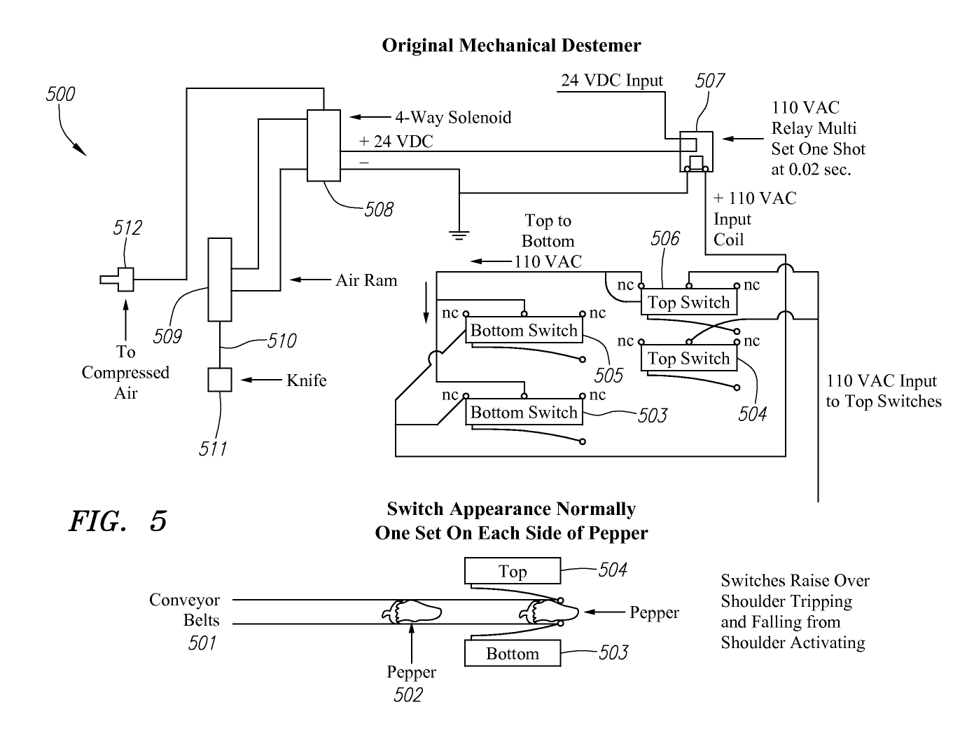

FIG. 5 is a schematic showing a pepper de-stemmer utilizing mechanical shoulder recognition 500. As previously described, mechanical switches 503, 504, 505 and 506 may be utilized to implement the method of shoulder recognition. As shown, a conveyor belt 501 causes a pepper 502 to travel up to and contact a pair of mechanical switches 503, 504. Switches contact the pepper at the apex end and rise and fall over the body of the pepper as the shoulder of the pepper is approached. Once both switches 503, 504 begin to fall, a signal is sent to a knife assembly 509, 510 and 511 to cut the calyx off of the pepper when the pepper reaches the knife assembly.

To improve performance, a pair of switches may be used on the bottom of the pepper and on the top of the pepper as shown. Increasing the number of switches tends to improve the triggering of the knife assembly particularly for irregular shaped whole peppers. As shown, a relay 507 is tripped and after an exemplary delay of 0.02 seconds a 4-way air solenoid 508 is activated. An air ram 509 pushes a knife blade 511 down, de-stemming the pepper at the appropriate time. Depending upon the machinery used, and the parameters governing the machinery such as belts speed inclination and the like, the time interval between the activation of the knife and the detection of the shoulder may vary.

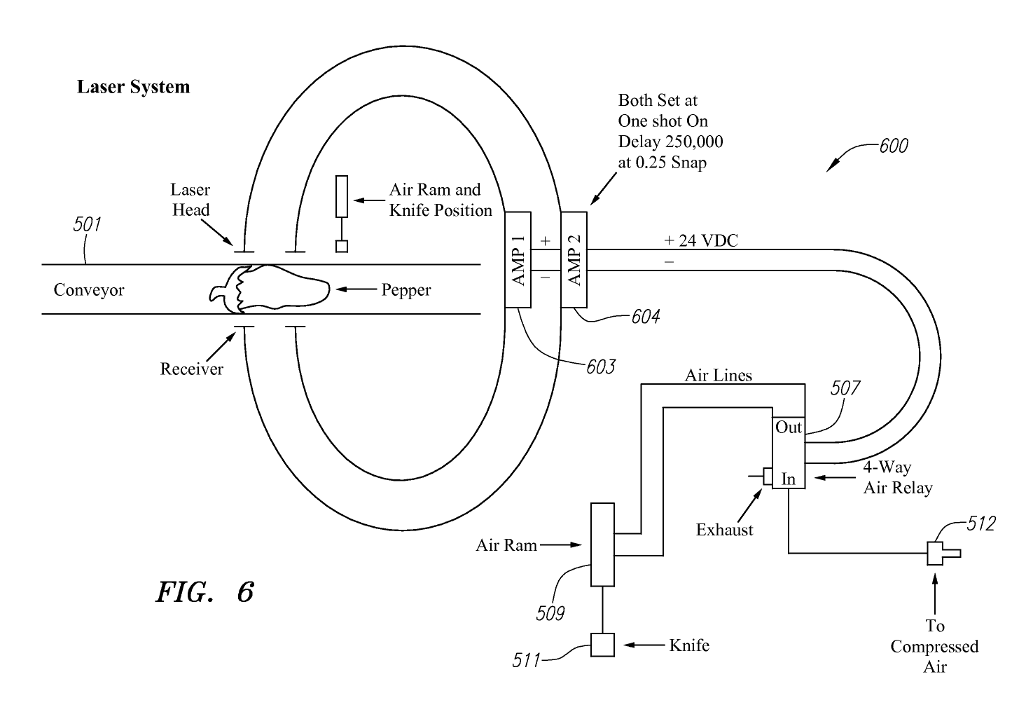

FIG. 6 is a schematic showing a pepper de-stemmer utilizing laser shoulder recognition 600. The laser vision system typically utilizes a pair of lasers 602 and corresponding receivers 602 to detect the light. A pepper may be lying on a belt 501 that is fed past the sensors 601 and lasers 602, or it may be fed through an inclined chute into belts. The pepper typically interrupts the laser beam as it passes by the sensors. The sensors may be disposed more or less parallel to each other at each side of the pepper's path. The pepper is typically oriented such that the pepper body interrupts the laser beam at the apex end first. First, the apex end of the pepper interrupts the laser beam on both sides at each receiver. Next, as the shoulder slopes away from the body of the pepper, the laser beam is unblocked causing the air ram 509 and knife 511 to be activated after an appropriate time. After interrupting the laser beams, the pepper travels past the air ram and knife assembly for de-stemming. A pair of amplifiers 603, 604 are typically utilized, one set to a one shot in the range of 25,000 at 0.025 snap. Amp 2 607 produces a 24 volt DC output causing a 4-way air relay to be activated. The output of the air relay 507 provides air to actuate the air ram 509 having a knife 511 disposed at the end of the air ram's piston. The air relay 507 is operated by conventionally supplied compressed air 512 and may include an exhaust.

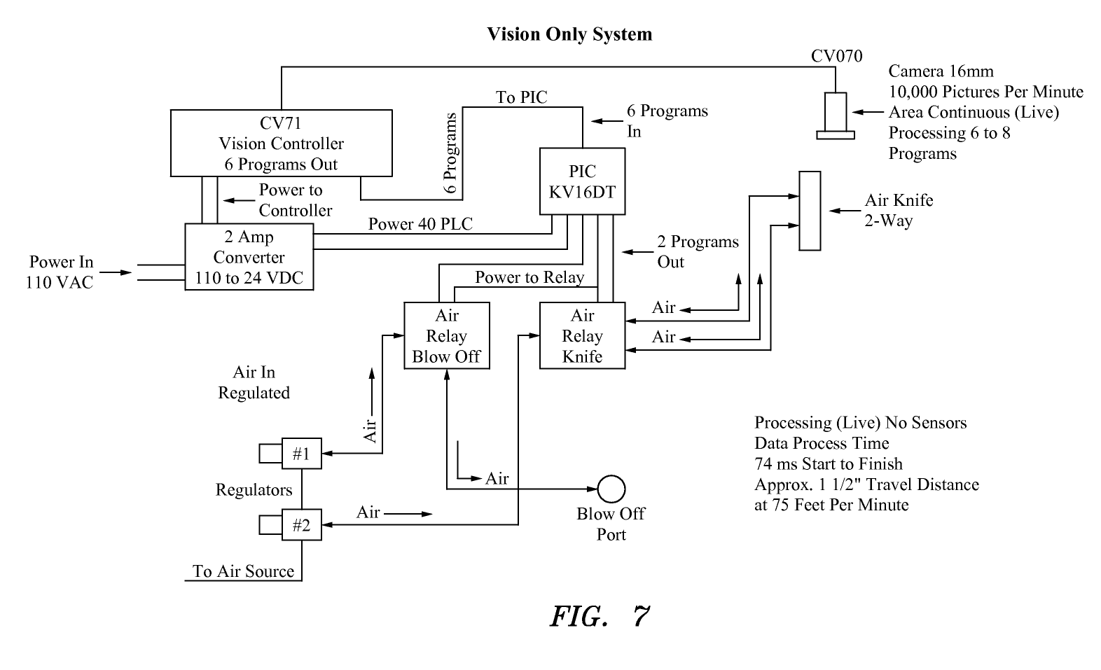

FIG. 7 is a schematic showing a whole pepper de-stemmer utilizing machine vision shoulder recognition. A vision only whole pepper de-stemming system, include whole peppers disposed at various positions as they pass underneath the de-stemming machinery. A conveyor belt is provided so that the whole peppers lie on the belt and pass under the vision system. An encoder is coupled to the conveyor belt to tell the programmable logic controller (“PLC”) how fast the conveyor belt is moving. As the pepper rests on the belt, and travels towards the pepper de-stemming machinery, lighting may be provided, such as by a fluorescent light or its equivalent, to illuminate the whole pepper so that a proper image may be made by the camera. A conventional optical sensor is provided to trigger the camera, causing an image of the whole pepper to be made which is sent to the PLC.

The PLC utilizes data encoding software to process the image made by the camera. The PLC is able to determine the orientation of the whole pepper, that is whether the apex or the stem end is traveling first into the de-stemmer. This eliminates the need to orient or singulate whole peppers prior to de-stemming. The PLC determines which end of the whole pepper is passing through first, and by recognizing the image of the whole pepper is able to adjust the signal provided to the knife to cut off the pepper's calyx. In addition, the time to cut off the stem is calculated by taking the encoder reading into consideration when sending signal to the air ram. As previously described, an air relay operates off of a 24 volt DC signal provided to it to supply air to the air ram actuating the knife.

In addition to recognizing which end of the whole pepper is present in timing the actuation of the knife, the vision system is able to examine the peppers and determine pepper color and quality by comparing known data points. The PLC issues a “don't cut” signal which is provided when discolored, crooked peppers or otherwise defective peppers are detected. A 24 volt DC signal from the don't cut line is provided to an air activated solenoid such that the rejected whole pepper passes through the de-stemmer uncut. Rejected peppers may be ejected to a conveyor belt carrying them to a rejects bin by a jet of air or other equivalent methods.

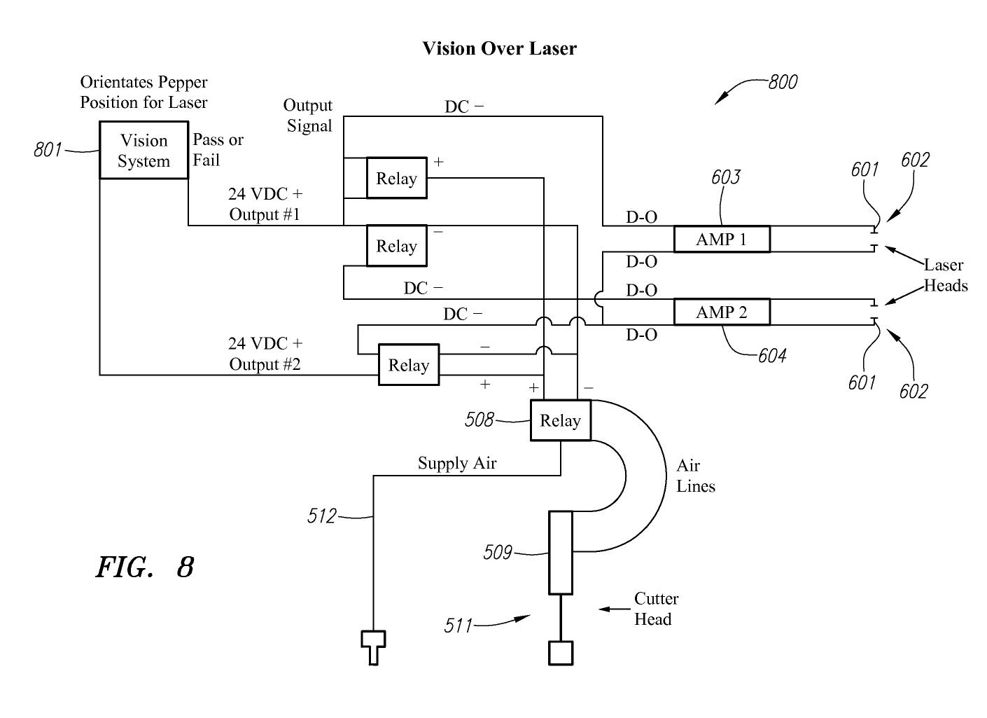

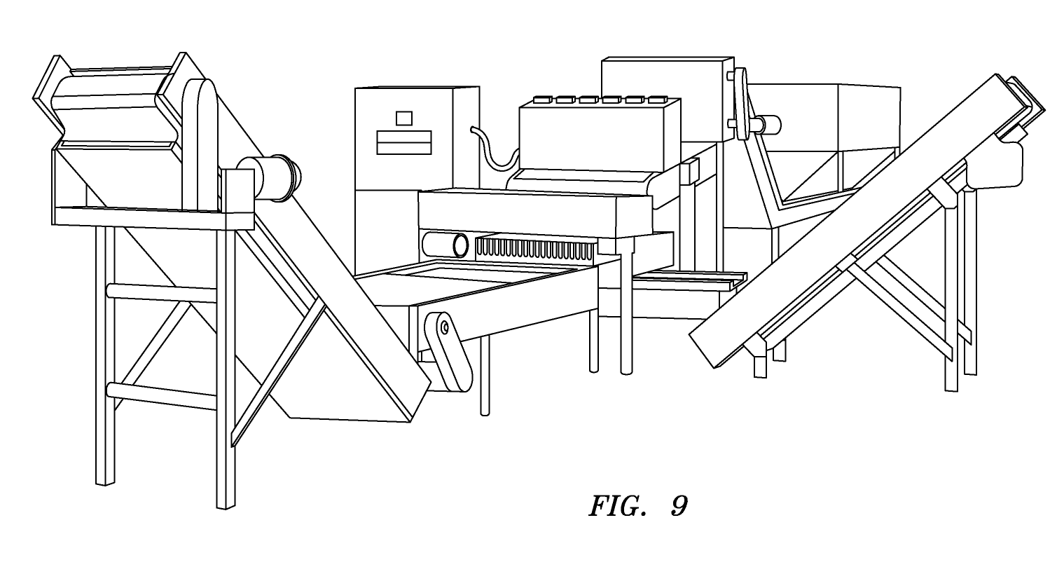

FIG. 8 is a schematic showing a whole pepper de-stemmer utilizing machine vision and laser shoulder recognition 800. A combination of a vision and laser system may also be provided. A vision system 801 typically orients whole peppers and provides a pass or fail output for rejecting miss-shaped or discolored peppers. Once the pepper passes the vision system 801, a pair of laser heads 601, 602 coupled to amplifiers 603, 604 create a trip signal to activate the air ram 509 causing the cutter head 511 to clip the calyx and stem off the whole pepper. Otherwise the vision systems and laser systems operate as previously described.

FIG. 9 shows a perspective view of an example of a whole pepper de-stemming machine utilizing machine vision for shoulder recognition and a belt system to feed whole peppers for de-stemming 901. This figure shows an exemplary whole pepper de-stemmer having a conveyor belt feed preceded by a vibrating conveyor for vibrating laning. The example includes 20 conveyor belts suitable for a modularized design of a whole pepper de-stemmer. The conveyor belts carry the peppers to the vision system that operates as previously described. In this example, the control electronics are disposed at the side of the prototype assembly. Such an assembly when sufficiently modularized, may allow improved maintenance. The entire de-stemmer apparatus may also be constructed as a module, for incorporation in larger production lines for whole pepper processing.

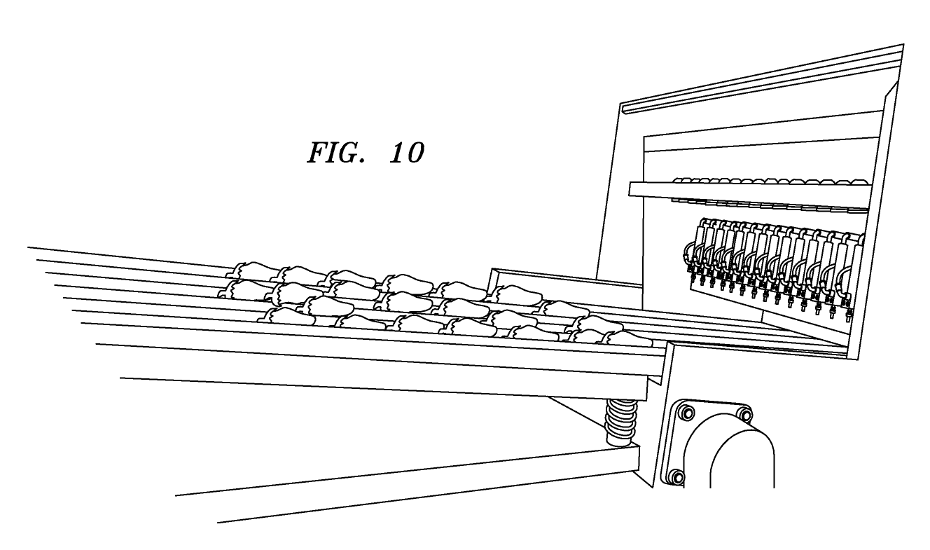

FIG. 10 shows a side view of the example of a whole pepper de-stemming machine 901 utilizing machine vision shoulder recognition and a belt system to feed whole peppers for de-stemming. This view shows a side view of the prototype whole pepper de-stemmer with the horizontal belts.

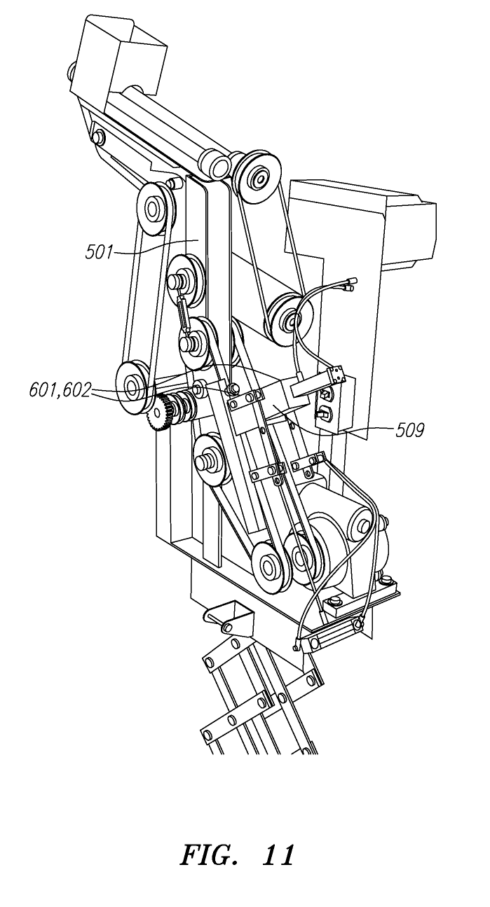

FIG. 11 shows a perspective view of an example of a whole pepper de-stemming machine utilizing laser shoulder recognition and a 20 lane system to feed whole peppers for de-stemming. Whole peppers are singularized by placing them in the hopper with apex first orientation. Whole peppers pass through the hopper and drop through a tube where they are ejected on a belt assembly 501. At the end of the belt assembly, are the laser sensors and the laser sources 601, 602. The whole pepper interrupts the laser beam utilizing the previously disclosed method of shoulder recognition 600 to activate the air ram 509 that chops the calyx and stem off of the whole pepper. Gravity causes the pepper to fall from the bottom of the air ram assembly. Control electronics are provided by modular assemblies on the side of the unit. Air and AC power are external inputs supplied to the de-stemmer.

In this example, a series of drive belts 501 are used to guide the whole pepper into the de-stemming machinery. Drive belts may be V-belts or any equivalent type of belt. Two belts at this side of the whole pepper are used to guide the whole pepper into the de-stemmer, with two belts being disposed at the bottom of the whole pepper to carry it through. All the belts typically run at the same, or nearly the same, operating speed.

In feeding whole peppers through the de-stemming machine, gravity feed may be utilized so that the whole peppers drop through the de-stemmer. In an alternative example, the whole peppers are fed horizontally or substantially horizontally on a conveyor belt.

At the shoulder end of the whole pepper, a pair of sensors beneath the whole pepper may detect light shining on both sides of the whole pepper, or at two data points. While, at the apex end of the whole pepper that curls, the same two sensors would only detect one light data point as the whole pepper passes over the sensor. The curling end of the whole pepper would obscure one sensor from receiving light while the other side of the sensor would detect light. In the exemplary configuration, four data points or sensors are provided to detect the shoulder of the whole pepper with two sensors typically needed to recognize the shoulder.

After the lined up whole peppers are fed into the whole pepper de-stemming machine, the sensors help determine where the shoulder of the whole pepper is located. A time delay is built in such that once the whole pepper shoulder is recognized, the whole pepper travels to a knife assembly or an equivalent cutting device in a precalculated amount of time where the calyx and stem are chopped or cut off.

In a typical example, the knife assembly is pneumatically extended and pneumatically retracted. The knife blade itself may be in a chisel type configuration for chopping or cutting off the calyx. In an alternative example, dual knives may be used. Since the whole pepper falls through the assembly and the knife blade contacts the whole pepper, it tends to slip causing inaccuracy in the de-stemming procedure.

In another alternative example, a mechanism to hold the whole pepper in place while it is being cut may also be provided. The mechanism to hold the whole pepper in place could be a spring loaded hold down, a boot, (such as a rubber boot), or a forked assembly to hold the whole pepper in place while it is being de-stemmed.

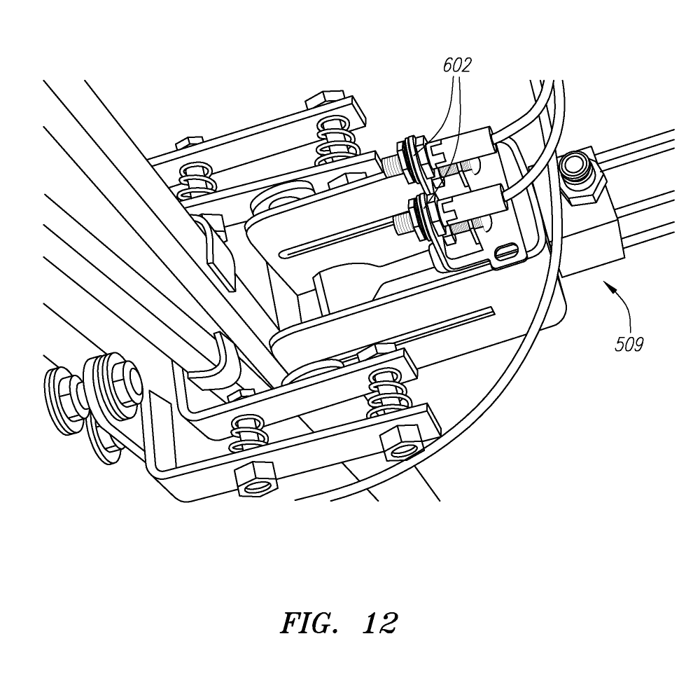

FIG. 12 shows a side view of an example of a whole pepper de-stemming machine utilizing laser shoulder recognition and an inclined quadruple belt system to feed whole peppers for de-stemming. This figure shows a close up of the air ram assembly 509 and the laser sources 602 coupled to it. The piston assembly from the ram 509 is disposed on a bracket that supports the knife 511. The belt assembly 501 carries the whole pepper past the sensors (not shown) and sources 602 to cause an interruption in the laser beam. The control electronics process the sensor inputs in order to activate the knife blade 511 at the proper time. The machine as described above, may be formed onto modular assemblies suitable for assembly into a production line.

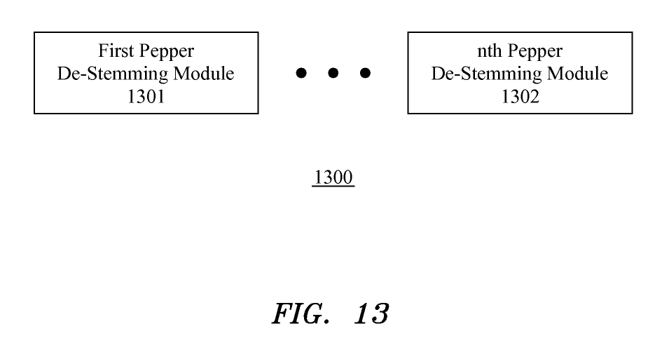

FIG. 13 shows an assembly of modularized whole pepper de-stemming machines 1301, 1302 into a production line for flexibility in production capacity and maintenance. The whole pepper de-stemming machine may be configured such that an exemplary multiple production lines of whole pepper de-stemming may be provided. That is multiple machines 1301, 1302 each having 20 lines of processing may be coupled together. Modularity allows the repair of broken machines without shutting down a whole line, and also allows small production facilities to tailor the processing to the size of their operation.

By modularizing or componentizing the whole pepper de-stemming apparatuses, flexible production lines may be established. Any number of whole pepper de-stemming modules that may be built as previously described may be coupled together to accommodate large volume of whole peppers or implement a desired production rate. The whole pepper de-stemming modules operate somewhat independently and may be bolted or placed in any convenient location to facilitate the processing of whole peppers. The modules themselves may be serviced easily since they are modular, and the components on each whole pepper de-stemming module may be further modulized for ease at replacement and servicing. Thus, if one whole pepper de-stemming module were to malfunction, it may be replaced until satisfactory service can take care of it without substantially slowing the flow of production.

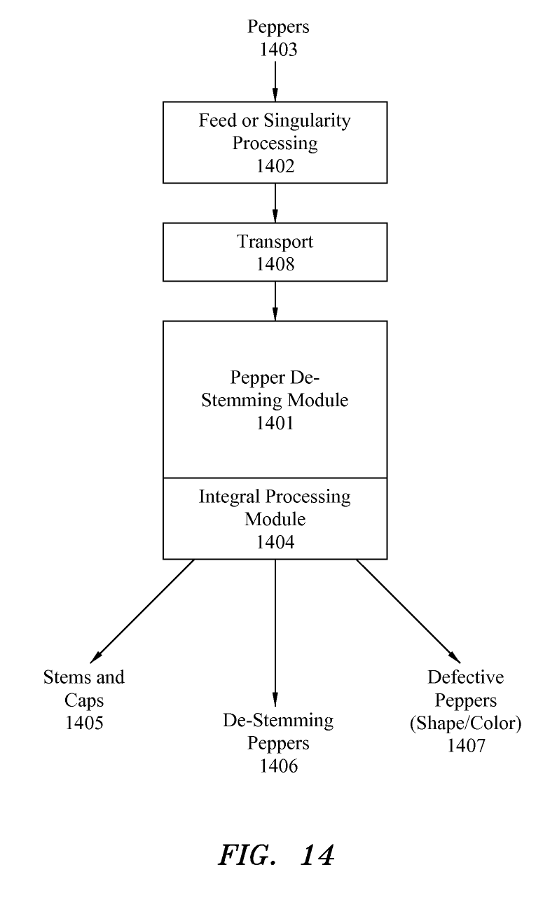

FIG. 14 shows an example of a whole pepper de-stemmer 1401 that may be built as previously described working in conjunction with additional components for processing whole peppers such as singularity processing, grading and the like. By utilizing modular construction, the whole pepper de-stemming module 1401 may be coupled to other components 1402 and 1404.

As shown, whole peppers 1403 are fed to an optional feed or singularity processing modules 1402 where they are in turn fed into a whole pepper de-stemming module 1401, after being de-stemmed, the whole peppers may pass through one or more integral processing modules, such as 1404 where stems and calyxs may be ejected 1405 and defective whole peppers 1407, or de-stemmed whole peppers 1406 may be outputted. An additional processing module 1404 may be utilized to further process the de-stemmed whole peppers. Defective whole peppers may include those that are blemished, discolored or have an undesirable shapes.

In addition to, conventional methods of selective harvesting practiced in the field, color sorting at the warehouse may be performed utilizing the vision version of the whole pepper de-stemming. Color sorting at the warehouse using a conventional color sorter has a typical efficiency of 80%. With the machine vision version of the whole pepper de-stemmer, a typical color sorting efficiency is approximately 100%.

Whole pepper de-stemming is typically done in the field when the whole peppers are being harvested. By utilizing an automatic pepper de-stemmer as described above, manual labor may be reduced and the production output of de-stemmed whole peppers may be increased. A typical processing speed for a pepper de-stemming machine is approximately 2.5 whole peppers per second, per line. Thus, an approximate output of a 20 line whole pepper de-stemming operation would be approximately 50 whole peppers per second.

In processing the whole peppers, a singularity process 1402 is typically first utilized to put the whole peppers in line before de-stemming. Singularity may be accomplished by placing the whole peppers in line by hand or by mechanical means so that the calyxes are all at the same orientation entering the de-stemming machine using a mechanical means so that the whole peppers may be placed in line having mixed orientation of stem to apex. The mixed stem to apex orientation of whole peppers may be utilized in the machine vision whole pepper de-stemmer. An orientation having the stem and calyx in the same position would be utilized in a mechanical switch version, or a laser version of the whole pepper de-stemmer. Once oriented properly, the whole peppers are fed to a sensing mechanism.

The whole peppers may be transported 1408 through a belt system from a tube hopper or other suitable input device. In an example of the pepper de-stemmer, 4 v-belts are configured such that the pepper rests on 2 v-belts and the remaining 2 v-belts travel along the side of the pepper providing enough friction to push it into or through the whole pepper de-stemmer mechanism.

In the machine vision version of the whole pepper de-stemmer, a micro processor is utilized to control the vision component of the whole pepper de-stemmer. The processor typically includes software which accepts the sensor data as inputs, processes the inputs and then provides control outputs for detecting the orientation of the whole pepper, determining the color of the whole pepper, determining if the whole pepper is defective and shoulder recognition. The micro processor also provides control signals carrying out for disposal of defective whole peppers, and the calyx, as well as sorting from the primary receptacle or bin, to an auxiliary receptacle or bin for whole peppers not meeting the color criteria desired. The pepper de-stemmer may be coupled to other processing machinery 1404.

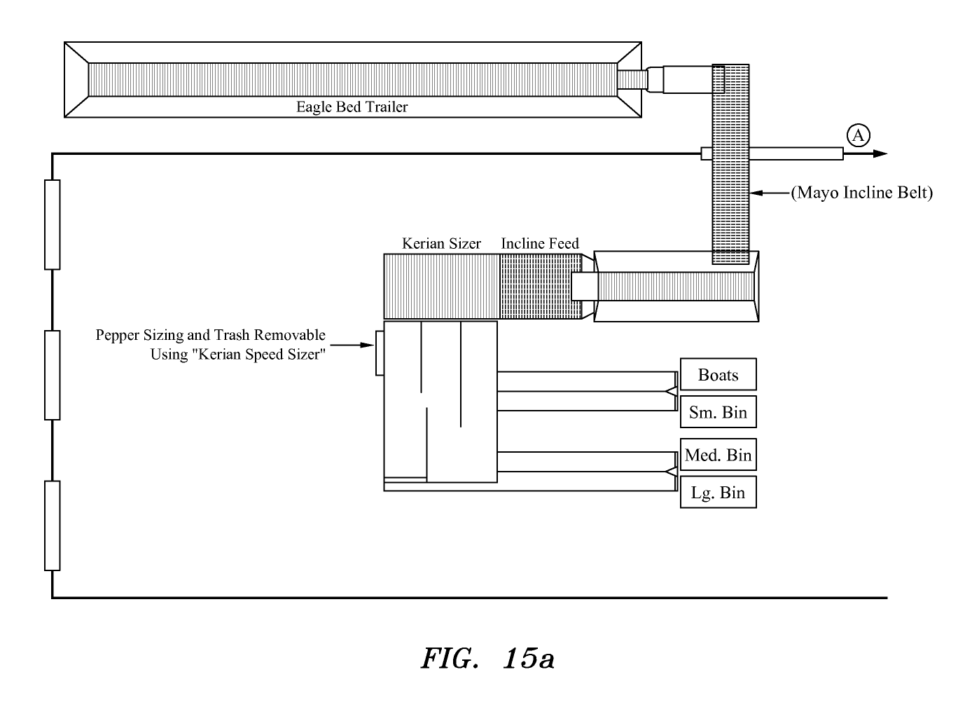

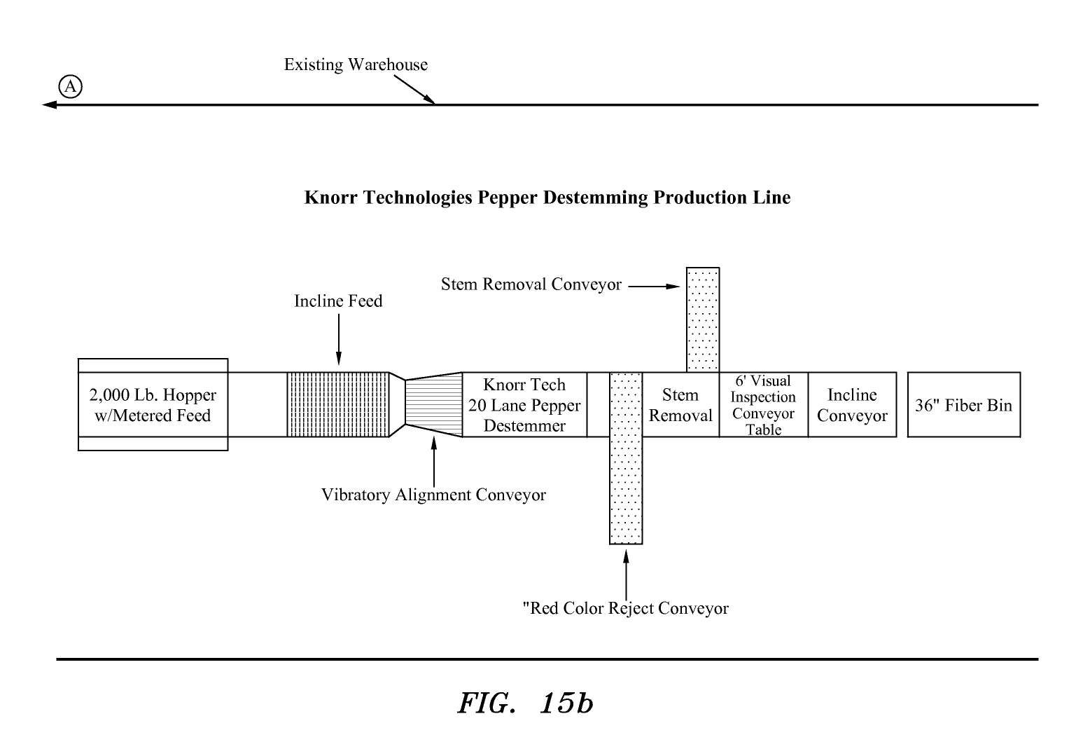

FIG. 15 shows a floor plan for a pepper processing facility utilizing pepper de-stemming machinery.

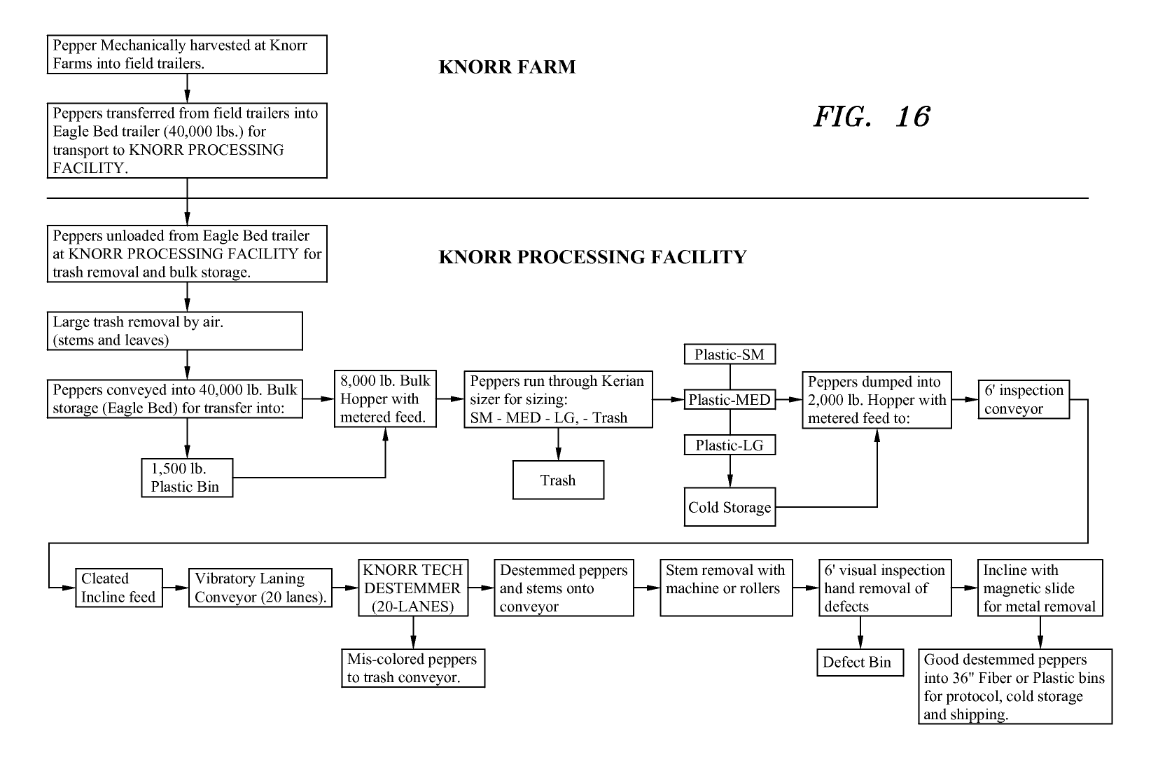

FIG. 16 is a flow diagram showing pepper processing in a facility utilizing pepper de-stemming machinery.

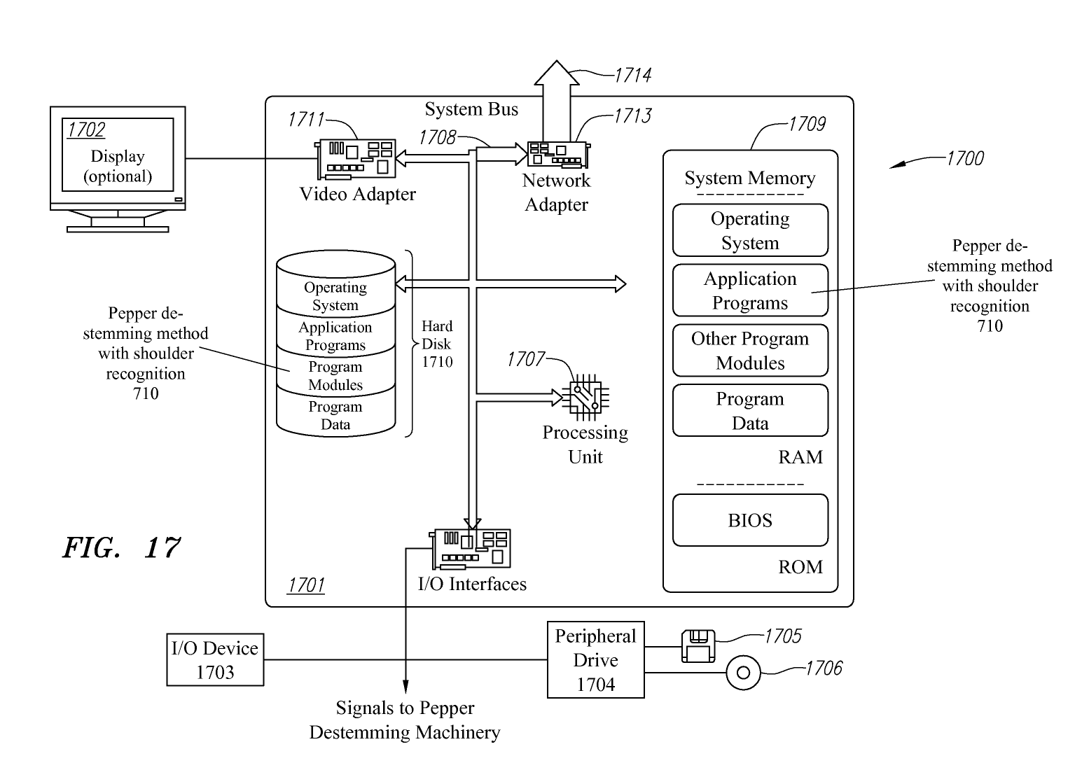

FIG. 17 is a block diagram of a computer system 1700 for providing control signals for implementing a method of de-stemming a pepper utilizing mechanical, or laser, shoulder recognition. Exemplary computing environment 1700 is only one example of a computing system and is not intended to limit the examples described in this application to this particular computing environment.

For example the computing environment 1700 can be implemented with numerous other general purpose or special purpose computing system configurations. Examples of well known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 1700 includes a general-purpose computing system in the form of a computing device 1701. The components of computing device 1701 can include one or more processors (including CPUs, GPUs, microprocessors and the like) 1707, a system memory 1709, and a system bus 1708 that couples the various system components. Processor 1707 processes various computer executable instructions, including those to provide shoulder recognition and other de-stemmer control signals and to control the operation of computing device 1701 and to communicate with other electronic and computing devices (not shown). The system bus 1708 represents any number of several types of bus structures, including a memory bus or memory controller, a peripheral bus, an accelerated graphics port, and a processor or local bus using any of a variety of bus architectures.

The system memory 1709 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 1707. Mass storage devices 1704 may be coupled to the computing device x01 or incorporated into the computing device by coupling to the buss. Such mass storage devices 1704 may include a magnetic disk drive which reads from and writes to a removable, non volatile magnetic disk (e.g., a “floppy disk”) 1705, or an optical disk drive that reads from and/or writes to a removable, non-volatile optical disk such as a CD ROM or the like 1706. Computer readable media 1705, 1706 typically embody computer readable instructions, for pepper de-stemming data structures, program modules and the like supplied on floppy disks, CDs, portable memory sticks and the like.

Any number of program modules can be stored on the hard disk 1710, Mass storage device 1704, ROM and/or RAM, including by way of example, an operating system, one or more application programs, other program modules, and program data. Each of such operating system, application programs, other program modules and program data (or some combination thereof) may include an embodiment of the systems and methods described herein.

An optional display device 1702 can be connected to the system bus 1708 via an interface, such as a video adapter 1711. A user can interface with computing device 1701 via any number of different input devices 1703 such as a keyboard, pointing device, joystick, game pad, serial port, and/or the like. These and other input devices are connected to the processors 1707 via input/output interfaces 1712 that are coupled to the system bus 1708, but may be connected by other interface and bus structures, such as a parallel port, game port, and/or a universal serial bus (USB).

Computing device 1700 can operate in a networked environment using connections to one or more remote computers through one or more local area networks (LANs), wide area networks (WANs) and the like. The computing device 1701 is connected to a network 1714 via a network adapter 1713 or alternatively by a modem, DSL, ISDN interface or the like.

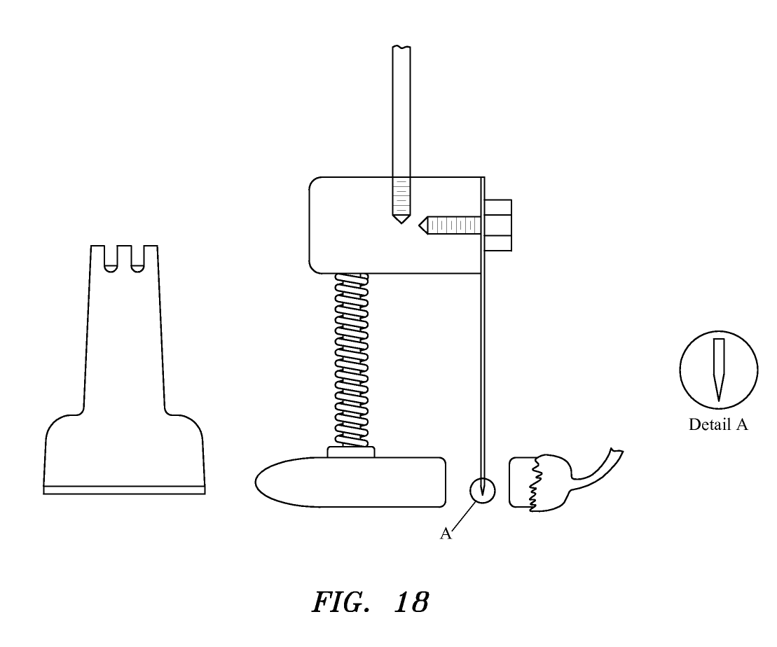

FIG. 18 shows a cutting assembly with a hold down to keep the pepper from moving or shifting when cut. The assembly attaches to the air ram piston. As the cutting assembly travels down, the pepper is held down by a spring loaded hold down or pod, before the blade cuts the pepper.

The appendix shows various views of an example of a vision based pepper de-stemming machine. This machine may use area continuance or real time processing for shoulder recognition as implemented by the exemplary Keyence Vision System. Sensors at the ends of the conveyor lines will shut the process down when metal such as from a broken cutter is detected. A card type size sorter, or its equivalent may be used to sort the cut stems from the pods and send them to the appropriate bins. An air jet is used to eject defective whole peppers from the de-stemmer to a conveyor belt going to a reject bin.

Those skilled in the art will realize that storage devices utilized to store program instructions for pepper de-stemming can be distributed across a network, in addition to residing local to a single controller. For example, a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions for pepper de-stemming may be carried out by a dedicated circuit, such as a DSP, programmable logic array, or the like.

1. A pepper destemmer comprising:
a means for sensing a shoulder of a pepper;
a controller to receive a signal indicating that the shoulder of the pepper has been determined; and
a knife assembly receiving a signal to activate from the controller.
